(19) United States
(12) Patent Application Publication
(10) Pub. No.: US 2015/0227288 A1
(43) Pub. Date: Aug. 13, 2015

(54) Selection of Third-Party Content Layers for a Digital Map

(71) Applicant: Google Inc., Mountain View, CA (US)

(72) Inventor: Andrew Foster, Naremburn (AU)

(73) Assignee: Google Inc., Mountain View, CA (US)

(21) Appl. No.: 14/178,072

(22) Filed: Feb. 11, 2014

(51) Int. Cl. G06F 3/0484; G06F 3/0482

(52) U.S. Cl. CPC G06F 3/04842; G06F 3/0482

(57) ABSTRACT

A method for providing geographic content via a user interface is implemented in a computing device. The method includes receiving, by one or more processors via a communication network, map data from a map data server. The method also includes generating, by the one or more processors, a digital map using the map data and generating, by the one or more processors, an interactive user interface (UI) element for selecting an additional content layer from among several content layers provided by third-party content providers operating independently of the map data server. The method also includes obtaining the selected content layer from the corresponding third-party content provider in response to a user selecting one of the plurality of content layers using the UI element.

### FIELD OF TECHNOLOGY

This application generally relates to interactive digital maps and, more particularly, to adding data from third-party content providers to digital maps.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Providers of online mapping services allow user devices to display interactive digital maps of selected geographic areas in web browsers or dedicated applications. Some providers also expose user controls for selecting additional information such as current traffic data, for example, to overlay a digital map. Further, some providers expose application programming interfaces (APIs) for embedding interactive digital maps in web sites. For example, an operator of a web site that provides real estate listings can invoke a mapping API to embed a digital map of a certain geographic area and request that a marker corresponding to a real estate listing be displayed on the digital map. Thus, a user device receives content to be displayed as part of a digital map either from a provider of the online mapping service alone, or from the provider of the online mapping service and a provider of online content that embeds a digital map.

### SUMMARY

Content providers create “layers” of information that can be displayed on a digital map from an online mapping service. The content providers can operate separately and independently of the online mapping service. The online mapping service maintains a registry of content layers. Individual users as well as providers of web content that embed digital maps from the online mapping service can subscribe to various combinations of these layers to create configurations map content unique to users, web sites, and/or providers of “native” applications. The online mapping service can provide user interface (UI) elements to allow users to peruse lists of available layers, select layers for subscription, activate previously selected layers, etc. The online mapping service also can provide an interface for content providers to register their content layers.

More particularly, an example embodiment of these techniques is a method in a computing device for providing geographic content via a user interface. The method includes receiving, by one or more processors via a communication network, map data from a map data server. The method also includes generating, by the one or more processors, a digital map using the map data and generating, by the one or more processors, an interactive user interface (UI) element for selecting an additional content layer from among several content layers provided by third-party content providers operating independently of the map data server. The method also includes obtaining the selected content layer from the corresponding third-party content provider in response to a user selecting one of the plurality of content layers using the UI element.

Another embodiment of these techniques is a system including a communication interface and processing hardware coupled to the communication interface. The processing hardware is configured to receive, from third-party content providers, indications of respective content layers compatible with digital maps provided by a map data server. Each of the third-party content providers operates independently of each other and of the map data server. The processing hardware is configured to store, in a content layer registry, indications of the content layers and the corresponding third-party content providers. Further, the processing hardware is configured to provide information stored in the content layer registry to a user device for overlaying one or more of the content layers over a digital map generated using map data from the map data server.

Yet another embodiment of these techniques is a system including a map database storing map data for generating an interactive digital map on a user device, a content layer registry, and non-transitory computer-readable medium storing instructions. The content layer stores content layer descriptors, each indicating a third-party content provider that provides a content layer for overlay on the digital map, where content layer providers operate independently of each other. The instructions stored on the computer-readable medium, when executed on one or more processors, cause the system to retrieve corresponding map data from the map database for a selected geographic area. The instructions further cause the system to retrieve, from the content layer registry, content layer descriptors for one or more content layers available for the selected geographic area, and provide the map content and the retrieved content layer descriptors to the user device.

### BRIEF DESCRIPTION OF THE DRAWINGS

FIG. 1 is a block diagram of an example communication system in which a user device receives map data for generating a digital map from an online mapping service and additional content layers for the digital map from third-party content providers;

FIG. 2 is a block diagram of an example user device that can operate in the communication system of FIG. 1;

FIG. 3 is a block diagram of an example content layer server that can operate in the communication system of FIG. 1;

FIG. 4A is an example screenshot of a mapping application with a UI element for activating content layer selection;

FIG. 4B schematically illustrates an example menu via which a user can select additional content layers, which can be implemented in the user device of FIG. 2;

FIG. 5A is a flow diagram of an example method for generating a digital map with additional content layers from third-party content providers, which can be implemented in the user device of FIG. 2;

FIG. 5B is a flow diagram of an example method for generating a digital map with additional content layers from third-party content providers, as specified by instructions in web content received from a web content provider, which can be implemented in the user device of FIG. 2;

FIG. 6 is a flow diagram of an example method for registering new content layers, which can implemented in the content layer server of FIG. 3; and

FIG. 7 is a flow diagram of an example method for managing user selections of third-party content layers received from a user device, which can implemented in the content layer server of FIG. 3.

### DETAILED DESCRIPTION

### Overview

Generally speaking, content providers create map content layers for overlaying digital maps and register these layers with a centralized registry, which can be maintained by an online mapping service, for example. These content layer providers operate separately and independently of each other and of the online mapping service, and are referred to in this disclosure as “third-party content providers.” When registering with the registry, a third-party content provider can provide a brief description of the content layer (e.g., “houses for sale in San Francisco”), an indication of access policy including such parameters as cost (free of charge, five dollars a month, etc.) and geographic restrictions (e.g., Japan only), an identifier of a server from which the content layer can be retrieved, etc.

In an example scenario, a web content provider embeds a digital map in a website and subscribes to one or several of content layers listed in the registry, so that users visiting the website can see additional content overlaying the digital map. More specifically, a user operating a user device visits the website and receives web content that includes instructions in a scripting language, for example. In accordance with these instructions, the user device obtains map data from the online mapping service as well as from one or several third-party content providers, renders a digital map using the map data, and overlays the content layers on the digital map. Depending on the implementation, the content layers can overlay the digital map automatically or upon confirmation from the user.

The user also can operate a UI element to invoke a menu for perusing the registry and selecting one or several of these additional content layers. The user can subscribe to one or several content layers to overlay a digital map received from the online mapping service via a dedicated application or a web site of the online mapping service, for example. In particular, the user can visit the web page of the online mapping service, provide his or her authentication information such as a login and password, position the viewport over a certain geographic region, and view the subscribed-to layers overlaid on the digital map automatically or upon confirmation. Further, in some embodiments, the user can overlay his or her subscribed-to content layers on a digital map embedded in a website of a web content provider operating separately and independently of the online mapping service.

In this manner, individual users and/or web content providers can create a large number of combinations of content layers according to their needs and interests. As a more specific example, a certain content provider offers school district data in the form of polygons that can be overlaid on a digital map, free of charge. Another content provider offers information about market trends in real estate which also can be overlaid on a digital map in the form of geographic markers, for a certain fee. A user subscribes to these two content layers so that, when a digital map is displayed on a certain web site, the user can activate her content layers to overlay the digital map (and, in some cases, the geographic content placed on the map by the web content provider).

### Example Computing System and Devices

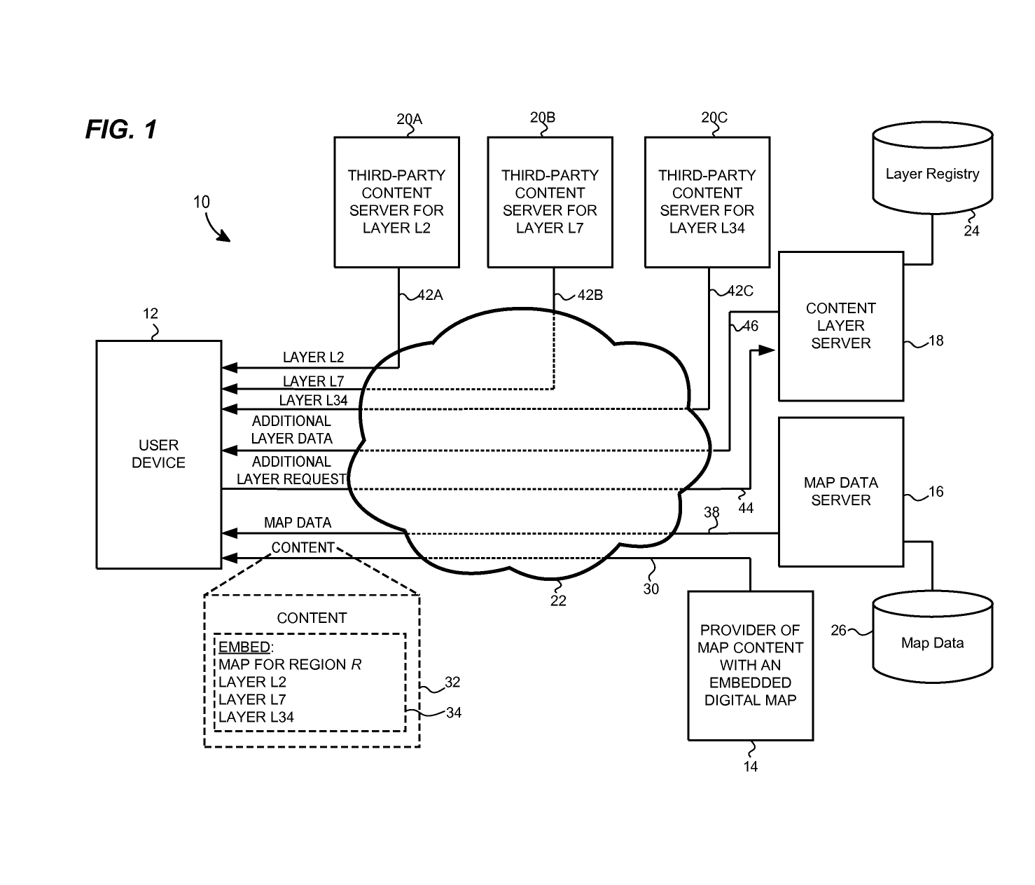

FIG. 1 illustrates an communication system 10 including a user device 12, a web content provider 14 that provides web content with an embedded map from a map data server 16, a content layer server 18, and third-party content providers 20A-C, interconnected via a communication network 22. The content layer server 18 is communicatively coupled to a content layer registry 24, and the map data server 16 is coupled to a map database 26.

In operation, the user device 12 requests data from web content provider 14. For example, a user can operate a web browser on the user device 12 and access a web site by specifying a Uniform Resource Locator (URL) that resolves to the address of the web content provider 14 on the communication network 22. The web content provider 14 in response (message 30) provides web content 32 that can include text, images, instructions in Hypertext Mark-up Language (HTML) and/or other mark-up and scripting languages, etc. The web content provider 14 also includes instructions 34 to embed a digital map and overlay the digital map with the content layers provided by the third-party content providers 20A-C.

As a more specific example, the instructions 34 can include a call to a mapping application programming interface (API) provided by the online mapping service with which the map data server 16 is associated. The online mapping service can expose, as part of the mapping API, one or several functions, data structures, constants, etc. The instructions 34 can include a call to the mapping API with parameters specifying, for example, the geographic region to be covered by the digital map and the zoom level. The instructions further can specify which content layers should be overlaid on the digital map, from which third-party content servers the user device 12 can retrieve additional content layers, whether the additional content layers should be displayed unconditionally or upon confirmation from the user, etc.

Thus, upon parsing the message 30, the user device 12 can retrieve map data from the map data server 16 (message 38). The map data in general can include any combination of vector graphics data, bitmap images, text, etc. The user device 12 can also request content layer data from the third-party content providers 20A-C, in accordance with the instructions 34 (messages 42A-C). Similar to the map data, content layers can include shapes defined in a vector graphics format, bitmap icons, text, et.

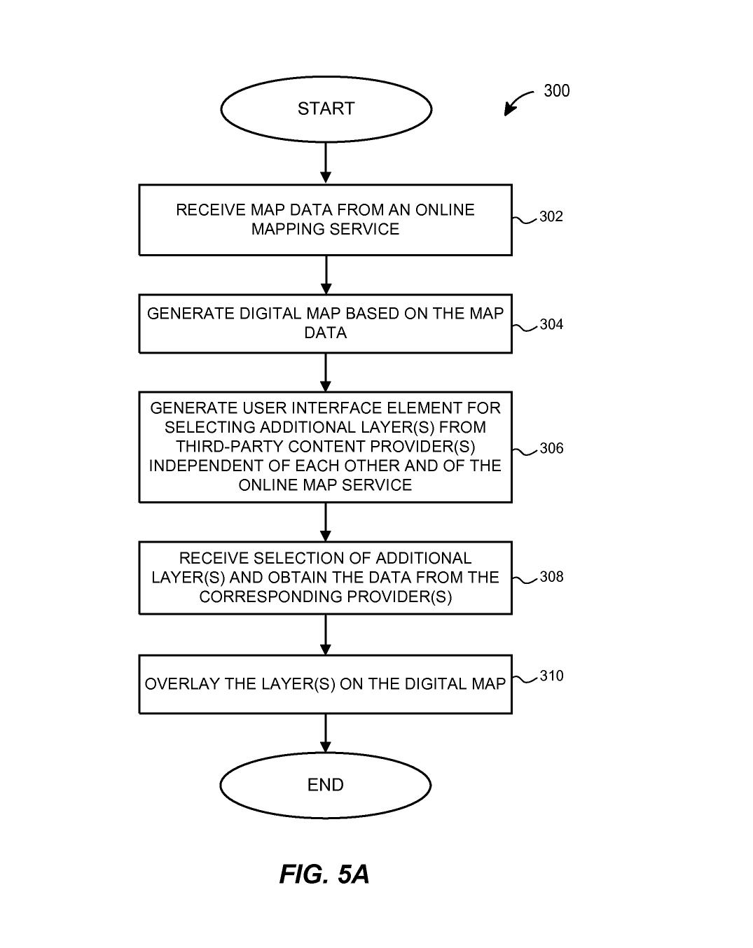

The user in some cases also invokes a UI element to select other available content layers listed in the layer registry 24, as discussed in more detail with reference to FIGS. 4A and 4B. The user device 12 and the content layer server 18 can exchange messages 44 and 46 regarding the available content layers, the format in which these content layers are available, access policies for these layers, subscription status (of the provider 14 and/or the user), etc. Moreover, the layer registry 24 in some implementations stores subscription information for users as well as subscription information for web content providers, such as the provider 14.

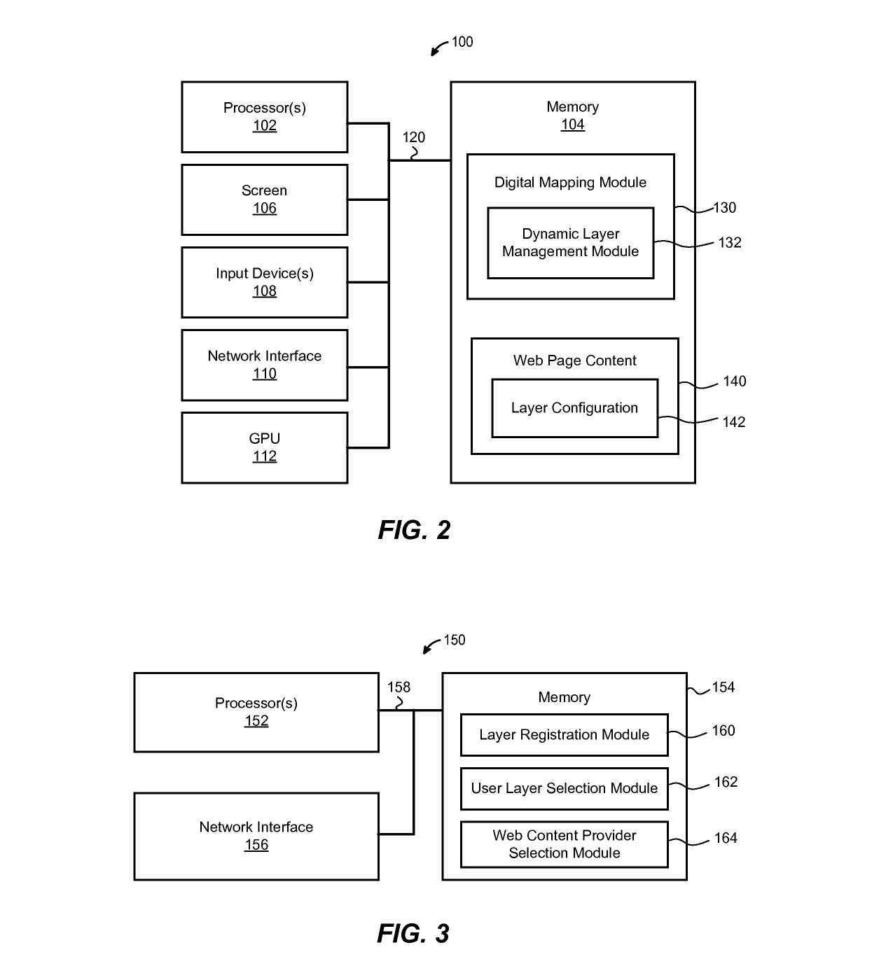

With continued reference to FIG. 1, the user device 12 can be a portable computing device such as a smartphone, a tablet computer, etc. or a non-portable computing device such as a desktop computer. The user device 12 can be coupled to the network 22, which can be a local area network or a wide area network such as the Internet, in a wired or wireless manner. An example implementation of the user device 12 is discussed below with reference to FIG. 2.

In another example scenario, the user operates a native application (developed specifically for the platform of the user device 12) rather than a web browser. The native application executes on the user device 12 to request data from the web content provider 14. The native application can implement the mapping API to retrieve map data, generate a digital map, etc. In this implementation, the native application can implement user interface elements similar to those discussed below with reference to FIGS. 4A and 4B. The mapping API also receives, interprets, renders, etc. content layer data.

For clarity, FIG. 1 illustrates each of the components 14, 16, 18, and 20A-C as a single device. In general, however, these components can be implemented as groups of computing devices of the same kind or different kinds. For example, the map data server 16 can correspond to multiple front-end servers and multiple back-end servers. Similarly, the content layer server 18 can be implemented as a set of servers organized according to any suitable scheme. Further, the map data server 16 and the content layer server 18 in some embodiments operate as a single network node associated with the same online mapping service, and are implemented as a single server or a group of servers. In other embodiments, however, the map data server 16 and the content layer server 18 can operate separately and can be associated with separate and independent online services.

In another implementation, an online service that operates the map data server 16 and/or the content layer server 18 also operates servers similar to the third-party content providers 20A-C. These servers can provide content layer data to a single server (or group of servers) from which the user device 12 can obtain multiple map layers. In an example embodiment, the content layer server 18 of FIG. 1 can receive content layer data from the servers 20A-C. The user device 12 can efficiently retrieve content layer data for multiple layers from the content layer server 18 without transmitting separate requests to the servers 20A-C.

Moreover, in some embodiments, the online mapping service discussed above operates the map data server 16 and the content layer server 18, where the content layer server 18 stores content layer data. In these embodiments, the user device 12 can simply request, from the map data server 16, a digital map of a geographic area with a set of content layers activated. The map data server 16 in response provides map data for rendering the digital map along with the corresponding content layer data for the activated layers, or automatically causes the content layer server 18 to provide content layer data. In any case, the user device 12 generates a common request to obtain all the necessary data.

Now referring to FIG. 2, a user device 100 can operate in the communication system 10 as the user device 12, or in another suitable computing environment. The user device 100 includes one or more processor(s) 102, such as a central processing unit (CPU), for example. The use device also includes a memory 104 readable by the processor(s) 102. The memory 104 can include one or several persistent memory modules such as a flash memory, hard disc, optical disc, etc. and/or one or several non-persistent memory modules such as a Random Access Memory (RAM) module. Further, the user device 100 can include a screen 106 as well additional output devices such as speakers, for example. The screen 106 in some implementations can be a touchscreen. Still further, the user device 100 can include one or more input device(s) such as a touchscreen, a keyboard, a mouse, a microphone, etc., a network interface 110 that supports long-range and/or short-range communication schemes, and a Graphics Processing Unit (GPU) 112 to render graphics content. The components 102-112 can be interconnected via a digital bus 120, for example.

The memory 104 stores a digital mapping module 130 that displays an interactive digital map via the screen 106. The digital mapping module 130 can include compiled instructions, non-compiled instructions interpreted by another software module, or both. The digital mapping module 130 can be, for example, a standalone application or a library or a plugin that implements a mapping API as discussed above for use by a web browser application. The digital mapping module 130 includes a dynamic layer management module 132 that obtains content layers from third-party content providers, overlays the content layers on the digital map, provides a UI element for subscribing to, activating, and removing content layers, and provides other functionality related to using and managing content layers.

The memory 104 also stores web page content 140 such as HTML content and multimedia content. The web page content 140 can include layer configuration information 142. Referring back to FIG. 1, the layer configuration information 142 can include instructions similar to the instructions 34 as well as information regarding the content layers to which the user subscribed, the information regarding the content layers which the user temporarily activated, etc.

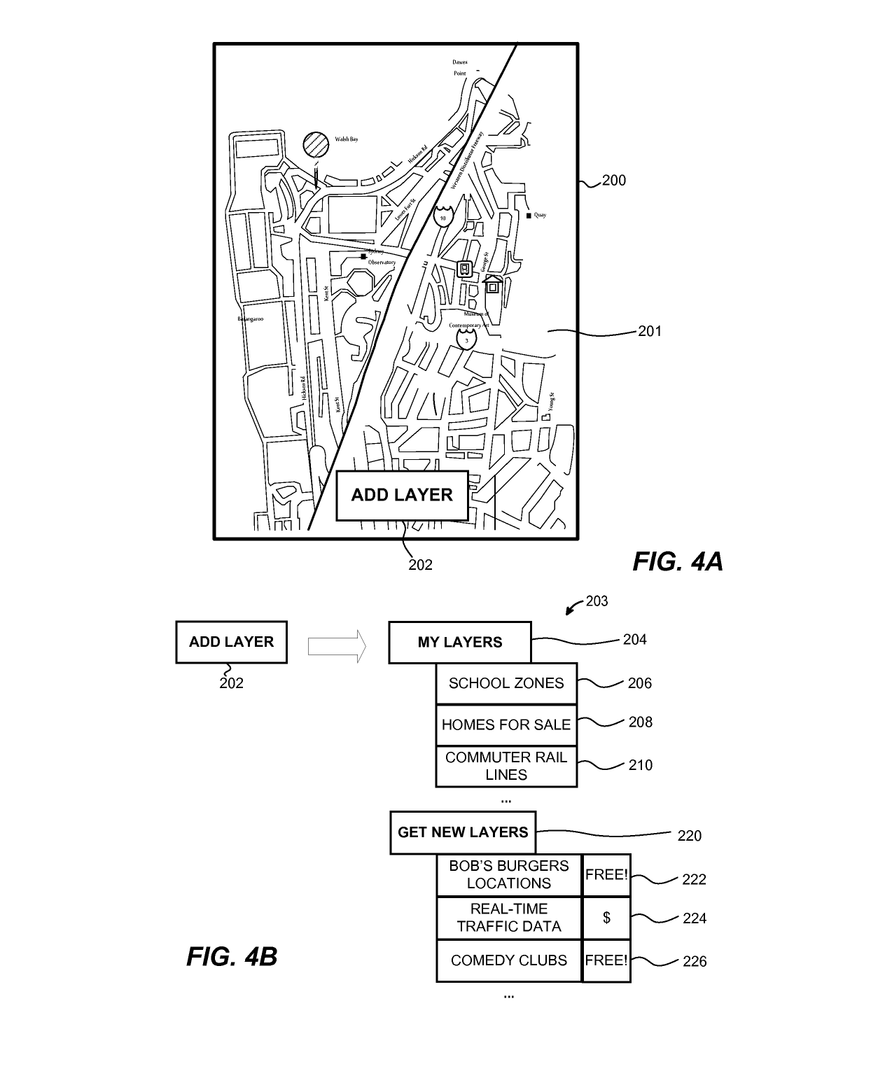

FIG. 3 illustrates an example server 150 which can operate as the content layer server 18 of FIG. 1, for example. The server 150 includes one or more processor(s) 152, a memory 154, and a network interface 156, interconnected via a digital bus 158. The memory 154 stores a layer registration module 160, a user layer selection module 162, and a web content provider selection module 164. Each of the modules 160, 162, and 164 can be implemented, for example, using software instructions executable on the processor(s) 152.

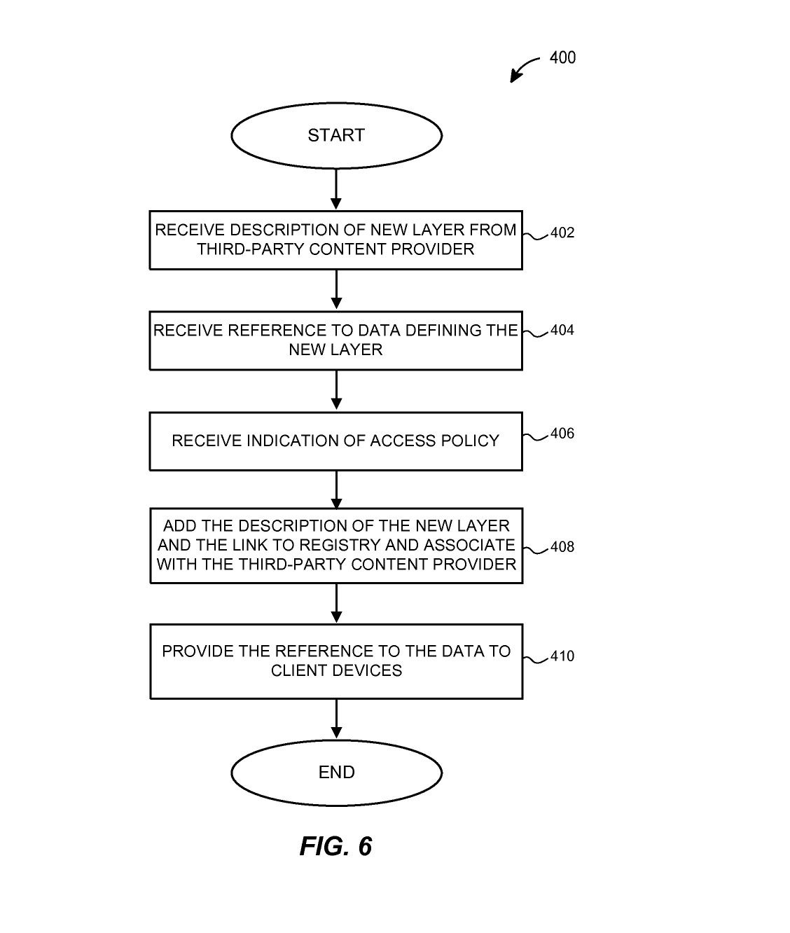

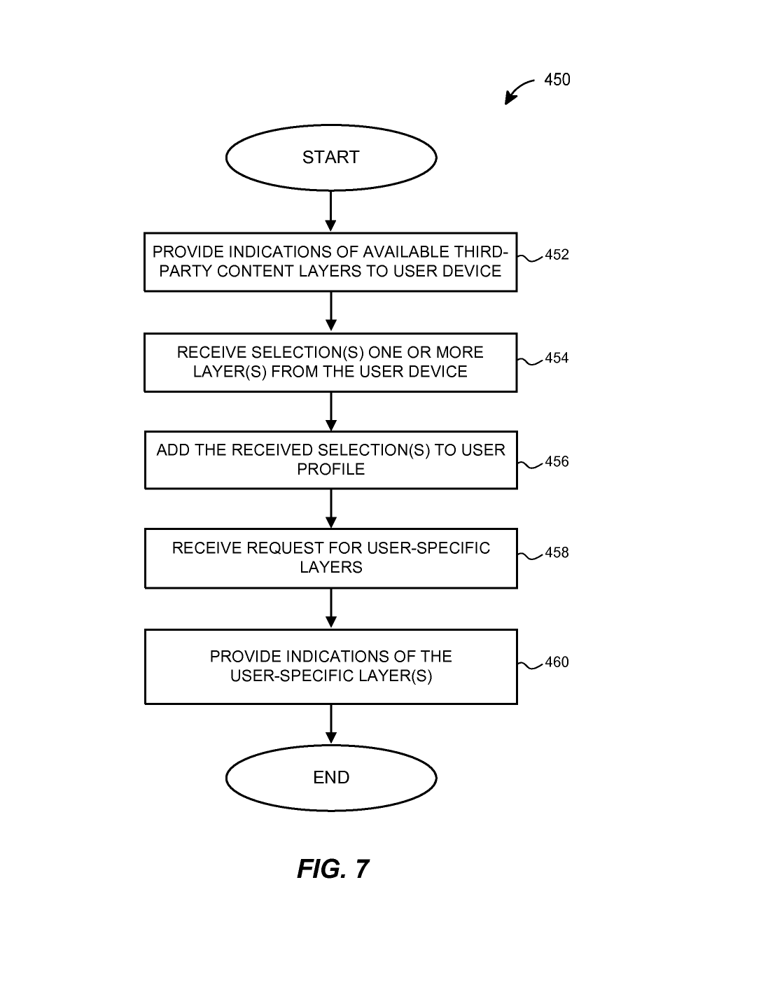

In operation, the layer registration module 160 receives information about new layers from third-party content providers and registers these new layers with a content layer registry (such as the layer registry 24 of FIG. 1, for example). The user layer selection module 162 operates to receive selections of content layers from a user operating a user device, activate the display of the selected content layers on the user device, and record the user's selections and preferences. Example operation of the layer registration module 160 and the user layer selection module 162 are discussed with reference to FIG. 6 and FIG. 7, respectively. Further, the web content provider selection module 164 operates to receive selections of content layers from a web content provider and these selections in a corresponding registry in the content layer registry, for example. The modules 160, 162, and 164 can communicate with the content layer registry via the network interface 156. As one alternative, the content layer registry can be implemented as a set of database tables in the memory 154.

Referring generally to FIGS. 2 and 3, it will be understood that the user device 100 and the server 150 can include additional components or, conversely, be implemented without some of the illustrated components. Further, two or more of the illustrated components can be implemented as a single component. Still further, some of the components illustrated as single blocks can be made up of multiple interconnected components.

### Example Interface for Selecting and Activating Additional Content Layers on a Digital Map

Next, FIG. 4A illustrates an example screenshot 200 which the digital mapping module 130 of FIG. 2 can display on the user device 100, for example. The screenshot 200 includes a digital map 201 with a UI element 202 for selecting and activating third-party content layers. When the user device 100 operates in the system 10 of FIG. 1, for example, the digital mapping module 130 can generate the digital map 201 using map data received from the map data server 16. The user device 100 can generate the digital map 201 in response to the user visiting a web site of the web content provider 14 or the web site of the online mapping service. In some implementations, a separate application rather than a web browser generates the digital map 201.

If the map data server 16 and the content layer server 18 are associated with the same online mapping service, the user can provide his or her authentication information to the online mapping service to access personal preferences, including the user's subscriptions to third-party content layers. However, if the map data server 16 and the content layer server 18 are associated with different services, the user may separately provide authentication information to the corresponding servers.

In any case, in response to the user actuating the UI element 202, the digital mapping module 130 can provide an interactive menu 203 schematically illustrated in FIG. 4B. The menu 203 includes a list 204 of the content layers to which the user is currently subscribed. The digital mapping module 130 can obtain the information in the list 204 from the content layer registry 24 via the content layer service 18. In this example, the user has subscribed to the school zone layer that provides polygons corresponding to school districts, defined in a vector format (item 206); a homes or sale layer that provides selectable geographic markers at various locations, such that a selection of a geographic marker triggers a display of the price, name of the real estate agent, etc. (item 208), and a commuter rail lines layer that provides lines representing suburban train routes, defined in a vector format, for overlay on a digital map (item 210). An organization overseeing school districts can provide the school zones layer, a real estate service can provide the homes for sale layer, and a regional transit authority can provide the commuter rail lines layer. Each of these providers operates separately and independently of each other and of the online map service with which the servers 16 and 18 are associated.

With continued reference to FIG. 4B, the interactive menu 203 also includes a list 220 of content layers available for subscription. In this example, a fast-food franchise layer includes information about the locations of participating restaurants (item 222), a real-time traffic data layer includes current traffic updates (item 224), and a comedy clubs layer provides locations of comedy clubs (item 226). The list 220 also indicates that the fast-food franchise layer and the comedy clubs layer are available free of charge, whereas the real-time traffic data layer is available for a subscription fee.

Using the interactive menu 203, the user can activate one or more of the content layers to which she previously subscribed, remove layers from the subscription, subscribe to new layers, etc. In some embodiments, the interactive menu 203 can offer additional functions, such as a search for content layers.

The online mapping service, or another service managing the content layer registry 24, can provide a generally similar interface (not shown) to web content providers. In particular, web content providers can choose various content layers for subscription, so as to allow users visiting their web sites to see these additional content layers unconditionally or upon confirmation. In at least some scenarios, third-party content providers can offer different subscription fees to individual users and web content providers.

Further, the online mapping service can provide another interactive menu (not shown) to third-party content providers via which they can register content layers and specify access policies, for example. The interactive menu for third-party content providers can be made accessible via a certain web site maintained by the online mapping service, for example.

Thus, the online mapping service (or another service managing the content layer registry) can offer a robust and easy-to-use “marketplace” of content layers to third-party content providers, web content providers, and individual users. If desired, the online mapping service can also contribute its own, “native” content layers to the content layer registry.

It is further noted that in some scenarios, a web content provider or a user can operate certain controls to make the display of certain content layers unconditional. In these situations, the user may not be able to operate the UI element 202 to unselect layers. Similarly, an option may be provided to a web content provider to disable the UI element 202 when a digital map is embedded in its website to also prevent users from adding third-party content layers.

Example Methods for Managing Content Layers that can be Implemented

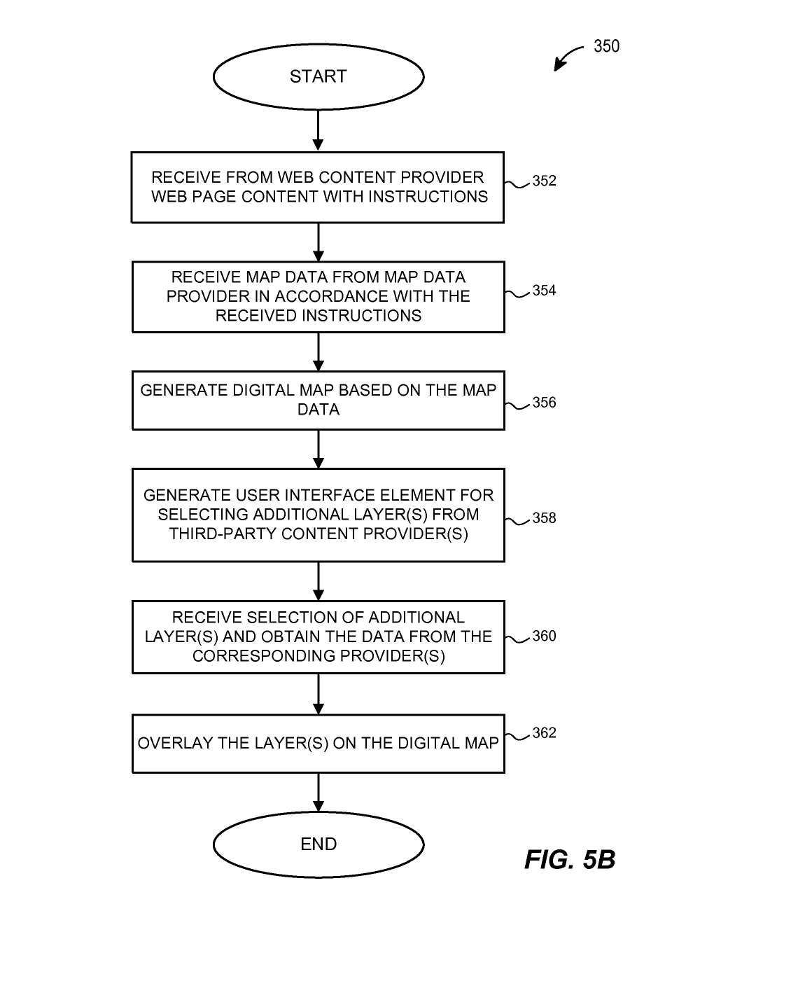

The example methods discussed next with reference to FIGS. 5A-7 can be implemented as sets of instructions stored on a non-transitory computer-readable medium and executable by one or more processors, for example.

First referring to FIG. 5A, an example method 300 for generating a digital map with additional content layers from third-party content providers can be implemented in the user device 100, for example. The method 300 begins at block 302, where map data for rendering a digital map is received from an online mapping service. A digital map is generated based on the received map data at block 304.

Next, a UI element is generated for selecting additional content layers from third-party content providers (block 306). A selection of one or more additional content layers is received at block 308. As discussed above with reference to FIGS. 4A and 4B, a user can select from among previously subscribed-to layers and/or a complete list of available content layers. At block 310, the corresponding content layer data is received and overlaid on the digital map. The method completes after block 310.

FIG. 5B is a flow diagram of an example method 350 for generating a digital map with additional content layers from third-party content providers, as specified by instructions in web content received from a web content provider, which also can be implemented in the user device 100, for example.

The method 350 begins at block 352, where web content is received from a web content provider. The web content can include instructions to embed a digital map. At block 354, map data is obtained in accordance with these instructions, and a corresponding digital map is generated at block 356.

Blocks 358, 360, and 362 can be generally similar to blocks 306, 308, and 310, respectively. However, at block 358, the user can be presented with a list of content layers to which the web content provider previously subscribed in addition to the list of content layers to which the user previously subscribed. In other words, a digital map in this case can include a combination of third-party content layers selected by the web content provider and the user (although the user in at least some of the embodiments can further modify these selections).

FIG. 6 is a flow diagram of an example method 400 for registering new content layers, which can implemented in the content layer server 150, for example.

At blocks 402-406, information regarding a new content layer is received from a third-party content provider. This information can include, for example, a brief user-friendly description of the content layer (block 402), an identifier of a server from which the content layer can be retrieved (block 404), and an indication of access policy including such parameters as cost, timing, geographic restrictions, age restrictions, etc. (block 406).

Next, at block 408, the information received at blocks 402-406 is added to a content layer registry. Depending on the implementation, one or multiple data records can be updated. At block 410, some or all of the information stored at block 408 is provided to users upon request.

Next, FIG. 7 depicts a flow diagram of an example method 450 for managing user selections of third-party content layers, which also can implemented in the content layer server 150, for example. This method begins at block 452, where indications of available third-party content providers are sent to a user device. Selections of one or more content layers then are received at block 454 and added to the user profile at block 456. Depending on the implementation, the user profile can be a data record in the content layer registry or a database that stores the user's preferences associated with the online mapping service.

Subsequently, a request for user-specific content layers can be received from the same user device or a different user device (block 458). In response, the indications of user-specific layers are provided to the requestor at block 460. Using these indications, the user can activate the display of these layers, view the terms of subscription, etc.

### Additional Considerations

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter of the present disclosure.

Additionally, certain embodiments are described herein as including logic or a number of components, modules, or mechanisms. Modules may constitute either software modules (e.g., code stored on a machine-readable medium) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

A hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module in dedicated and permanently configured circuitry or in temporarily configured circuitry (e.g., configured by software) may be driven by cost and time considerations.

Accordingly, the term hardware should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware and software modules can provide information to, and receive information from, other hardware and/or software modules. Accordingly, the described hardware modules may be regarded as being communicatively coupled. Where multiple of such hardware or software modules exist contemporaneously, communications may be achieved through signal transmission (e.g., over appropriate circuits and buses) that connect the hardware or software modules. In embodiments in which multiple hardware modules or software are configured or instantiated at different times, communications between such hardware or software modules may be achieved, for example, through the storage and retrieval of information in memory structures to which the multiple hardware or software modules have access. For example, one hardware or software module may perform an operation and store the output of that operation in a memory device to which it is communicatively coupled. A further hardware or software module may then, at a later time, access the memory device to retrieve and process the stored output. Hardware and software modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as an SaaS. For example, as indicated above, at least some of the operations may be performed by a group of computers (as examples of machines including processors), these operations being accessible via a network (e.g., the Internet) and via one or more appropriate interfaces (e.g., APIs).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” or a “routine” is a self-consistent sequence of operations or similar processing leading to a desired result. In this context, algorithms, routines and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description should be read to include one or at least one and the singular also includes the plural unless it is obvious that it is meant otherwise.

Upon reading this disclosure, those of skill in the art will appreciate still additional alternative structural and functional designs for providing third-party content layers for overlay on digital maps through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method in a computing device for providing geographic content via a user interface, the method comprising:
receiving, by one or more processors via a communication network, map data from a map data server;
generating, by the one or more processors, a digital map using the map data;
generating, by the one or more processors, an interactive user interface (UI) element for selecting an additional content layer from among a plurality of content layers provided by a plurality of third-party content providers operating independently of the map data server; and
in response to a user selecting one of the plurality of content layers using the UI element, obtaining the selected content layer from the corresponding third-party content provider; and
overlaying the selected content layer on the digital map.

2. The method of claim 1, wherein the selected content layer is a first content layer corresponding to a first content provider, the method further comprising:
in response to the user selecting a second content layer from among the plurality of content layers using the UI element, obtaining the second content layer from a second third-party content providers that operates independently of the first third-party content provider and of the map data server;
overlaying the second selected content layer on the digital map.

3. The method of claim 2, further comprising:
obtaining content layer registry information descriptive of the plurality of additional content layers; and
contacting the first third-party content provider and the second third-party content provider based on the content layer registry information.

4. The method of claim 1, further comprising:
receiving, by one or more processors via a communication network, web content including instructions from a web content provider;
wherein receiving the map data from a map data server is in response to the instructions included in the web content, and wherein the web content provider operates independently of the map data server and the third-party content provider.

5. The method of claim 1, wherein the instructions further specify the plurality of content layers available for selection using the UI element.

6. The method of claim 1, further comprising receiving, from the plurality of third-party content providers, indications of access policies for the plurality of content layers, wherein access policy for a content layer indicates at least a cost.

7. The method of claim 1, wherein obtaining the selected content layer includes receiving a set of one or more polygons with vertices corresponding to points on the map, wherein overlaying the selected content layer on the digital map includes rendering the set of one or more polygons.

8. A system including:
a communication interface; and
processing hardware coupled to the communication interface, the processing hardware configured to:
receive, from a plurality of third-party content providers, indications of respective content layers compatible with digital maps provided by a map data server, wherein each of the third-party content providers operates independently of each other and of the map data server,
store, in a content layer registry, indications of the content layers and the corresponding third-party content providers, and
provide information stored in the content layer registry to a user device for overlaying one or more of the content layers over a digital map generated using map data from the map data server.

9. The system of claim 8, wherein the processing hardware is further configured to:
receive a user identifier identifying a user of the user device,
receive an indication of one or more of the content layers selected by the user,
store the indication of the selected one or more of the content layers in a data record specific to the user, and
cause the content layers indicated in the data record to be automatically provided to the user device upon request.

10. The system of claim 8, wherein the processing hardware is further configured to:
receive an identifier of a web content provider that provides a web site with an embedded digital map,
receive an indication of one or more of the content layers selected by the web content provider,
store the indication of the selected one or more of the content layers in a data record specific to the web content provider, and
cause the content layers indicated in the data record to be automatically provided to the user device in response a user accessing the web site.

11. The system claim 8, wherein the processing hardware is further configured to:
receive, from the plurality of third-party content providers, indications of access policies for the corresponding content layers, and
store the indications of the access policies in the content layer registry.

12. The system of claim 11, wherein the access policy for a content layer indicates a cost of using the content layer to overlay the digital map.

13. The system of claim 11, wherein the access policy for a content layer indicates a geographic area for which the content layer is available.

14. A system comprising:
a map database storing map data for generating an interactive digital map on a user device;
a content layer registry storing a plurality of content layer descriptors, each indicating a third-party content provider that provides a content layer for overlay on the digital map, wherein each of the plurality of content layer providers operates independently of each other;
a non-transitory computer-readable medium storing thereon instructions that, when executed on one or more processors, cause the system to:
for a selected geographic area, retrieve corresponding map data from the map database,
retrieve, from the content layer registry, content layer descriptors for one or more content layers available for the selected geographic area, and
provide the map content and the retrieved content layer descriptors to the user device.

15. The system of claim 14, wherein the instructions further cause the system to:
receive, from the user device, an indication of identity of a user of the user device, and
retrieve the one or more content layers available for the selected geographic area based at least in part of the identity of the user.

16. The system of claim 15, wherein to retrieve the one or more content layers available for the selected geographic area, the instructions further cause the system to identify a set of content layers which the user previously selected for subsequent use with digital maps.

17. The system of claim 14, wherein the user device displays the interactive digital map in a web browser as a part of content of a web site, and wherein the instructions further cause the system to:
receive an indication of identity of a web content provider that provides the web site, and
retrieve the one or more content layers available for the selected geographic area based at least in part of the identity of the web content provider.

18. The system of claim 17, wherein to retrieve the one or more content layers available for the selected geographic area, the instructions further cause the system to identify a set of content layers which the web content provider previously selected for subsequent use with digital maps.

19. The system of claim 14, wherein the instructions further cause the system to provide indications of access policies for the retrieved content layer descriptors to the user device.

20. The system of claim 14, wherein the access policy for a content layer indicates a cost of using the content layer to overlay the digital map.
